(19) United States
(12) Patent Application Publication
(10) Pub. No.: US 2023/0027027 A1
(43) Pub. Date: Jan. 26, 2023

(54) SYSTEMS AND METHODS FOR WARRANTY RECOMMENDATION USING MULTI-LEVEL COLLABORATIVE FILTERING

(71) Applicant: Dell Products, L.P., Round Rock, TX (US)

(72) Inventors: Vaideeswaran Ganesan, Bangalore (IN); Praveen Lalgoudar, Bangalore (IN); Varsha Berya, Lalitpur (IN); Rushyendra Velamuri, Bangalore (IN); Abhishek Gupta, Rohini (IN); Pandiyan Varadharajan, Bangalore (IN)

(73) Assignee: Dell Products, L.P., Round Rock, TX (US)

(21) Appl. No.: 17/409,984

(22) Filed: Aug. 24, 2021

(30) Foreign Application Priority Data
Jul. 23, 2021 (IN) 202111033261

(51) Int. Cl. G06Q 30/00; G06Q 30/02; G06F 16/28; G06F 9/50

(52) U.S. Cl. CPC G06Q 30/012; G06Q 30/0282; G06Q 30/0204; G06F 16/285; G06F 9/5077; G06N 20/00

(57) ABSTRACT

Systems and methods are disclosed for warranty recommendations for users based upon warranty selections of peer users. The users are clustered into peer groups based upon industry or market segment based upon user data including primary variables, such as workload type data and market segment data, and secondary variables, such as virtual machine size or number, cluster size, cost, and downtime. New users are matched to a top similar user within their peer group based upon a vector distance, wherein the vector comprises the primary and secondary variables. A current warranty of the top similar user is recommended to the new user. Warranty changes by members of a peer group cause trigger an updated ranking of the peer group warranties. Expert user comments and rankings are used to generate expert user recommendations. A cost-based impact assessment may also be used for warranty recommendations by highlighting favorable and unfavorable warranty properties.

### CROSS REFERENCE TO RELATED APPLICATIONS

This patent application claims priority to co-pending, commonly assigned Indian Patent Application No. 202111033261, filed Jul. 23, 2021 and entitled “Systems and Methods for Warranty Recommendation Using Multi-Level Collaborative Filtering,” the entire contents of which are incorporated by reference herein.

### FIELD

The present disclosure generally relates to Information Handling Systems (IHSs), and, more particularly, to recommending an optical IHS warranty to users based on the user's community or market segment.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise blade servers that are stacked and installed within racks. A data center may include large numbers of such server racks that are organized into rows of racks. Administration of such large groups of IHSs may require teams of remote and local administrators working in shifts in order to support around-the-clock availability of the data center operations while minimizing any downtime. A data center may include a wide variety of hardware systems and software applications that may each be separately covered by warranties. The information available regarding warranties can be confusing for customers to understand the support level available for various IHSs in a data center.

### SUMMARY

In various embodiments, systems and methods are provided for selecting warranty recommendations for users based upon warranty selections of peer users, expert user advice, and cost-based impact assessment. The users are clustered into peer groups based upon industry or market segment. Peer groups are identified based upon user data including primary variables, such as workload type data and market segment data, and secondary variables, such as virtual machine size, a number of virtual machines, cluster size, cost, and a level of downtime. New users are matched to an existing peer group. The new users are then matched to a top similar user within their peer group based upon a vector distance, wherein the vector comprise the primary and secondary variables. A current warranty of the top similar user is recommended to the new user. Warranty changes by members of a peer group cause trigger an updated ranking of the peer group warranties. All members are notified of the updated ranking.

Expert user comments and rankings are collected from experienced users and existing customers. Warranties may also be ranked on the basis of expert user advice. Recognized experts in a selected industry or market segment may provide star ratings for warranties. These experts may also provide review comments in conjunction with the star rating. The expert user comments and rankings are used to generate expert user recommendations.

A cost-based impact assessment may also be used for warranty recommendations. Cost recommendations highlight warranty properties that are favorable and properties that may be impacted if the user makes a transition from one warranty to another. Different features associated with a warranty may be ranked as preferred, neutral, or not preferred within a particular industry or market segment. For example, features such as SLA, downtime, expert rankings, or peer group rankings may be presented to a customer for multiple warranties so that the customer can identify the advantages and disadvantages in each warranty from a cost point of view.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a block diagram illustrating certain components of a chassis supporting a plurality of IHSs and configured according to various embodiments.

FIG. 2 is a block diagram illustrating certain components of an IHS that may be a component of a chassis and is configured according to various embodiments.

FIG. 3 is a chart illustrating relative ratings of different warranties W1-W3 against attributes including downtime, SLA, peer group, and expert advice.

FIG. 4 is a flowchart illustrating a process for data preprocessing and recommendation according to an example embodiment.

### DETAILED DESCRIPTION

Existing warranty systems typically comprise a standard warranty for a particular device, such as an IHS, server, etc. The standard warranty comprises typical coverage that is offered to customers by a vendor, such as a manufacturer, seller, re-seller, or subcontracted service agent, upon purchase of the individual device, such as a typical server, memory device, or network device warranty. In some cases, the vendor may offer an extended warranty if that option is available. The vendor may support many types of warranties, which can make it difficult for a customer representative to select the correct warranty type applicable for the customer product. For a larger customer accounts, the vendor may allocate a dedicated Technical Account Manager (TAM), who can analyze the customer requirements and help the customers with required warranty types. Unfortunately, customers may experience extended system downtime or degraded functionality when a non-optimal warranty has been purchased for the device. There are multiple reasons that contribute to the selection of a non-optimal warranty, such as limited understanding of cost or available warranty offerings, or changes in device usage or intent after purchase.

Warranties typically have common features, such as warranty type that identifies the covered component types (e.g., software or hardware), a warranty replacement SLA that identifies the level of services expected by the customer from the vendor (e.g., next business day (NBD), second business day (SBD), four hours (4H), eight hours (8H), mission critical (MC), etc.), and a support type that identifies the types of support provided (e.g., engineer/technician level one, two, or three (L1, L1+L2, L1+L2+L3), Post Support, etc.) or other support based on standard naming conventions. The warranty will also identify a warranty start date and a warranty end date. The warranty SLA can have a significant impact on the customer's operations. For example, a server with an SBD warranty may experience downtime up to two days, which could have been reduced to four hours if a 4H response warranty was in place.

Certain scenarios can create negative customer experiences if the wrong warranty is in place. For example, a server's performance may be degraded for an extended time due to redundant part failures, such as failure of one drive in a Redundant Array of Independent Disks (RAID) virtual disk. A server may experience extended downtime due to the time required to replace a failed critical part, such as a CPU, memory, backplane, or system board failure. A servers may have to function with an extended risk due to redundant part failures, such as a power supply unit (PSU) or fan failure. Customer awareness of warranty coverage may also cause customer dissatisfaction. For example, if a customer is not aware that a certain failure is within warranty support, then the customer will never report the issue and may instead request part replacement, which may result in unnecessary downtime and cost that could have been avoided.

Existing warranty systems for data center devices, such as node, servers, clusters, etc. use standard collaborative filtering that is focused on a single recommendation for a new user. After recommending a warranty to a new user, the existing methods do not recommend updates for that user even if the recommendations change later. There are tools available that suggest a best warranty among available warranties for a specific workload; however, those tools do not consider or make recommendations based on the customer's peer group. When recommending warranties to a new user, existing systems do not consider the impact important properties such as SLA or server downtime. Additionally, existing warranty systems do not provide expert user recommendations.

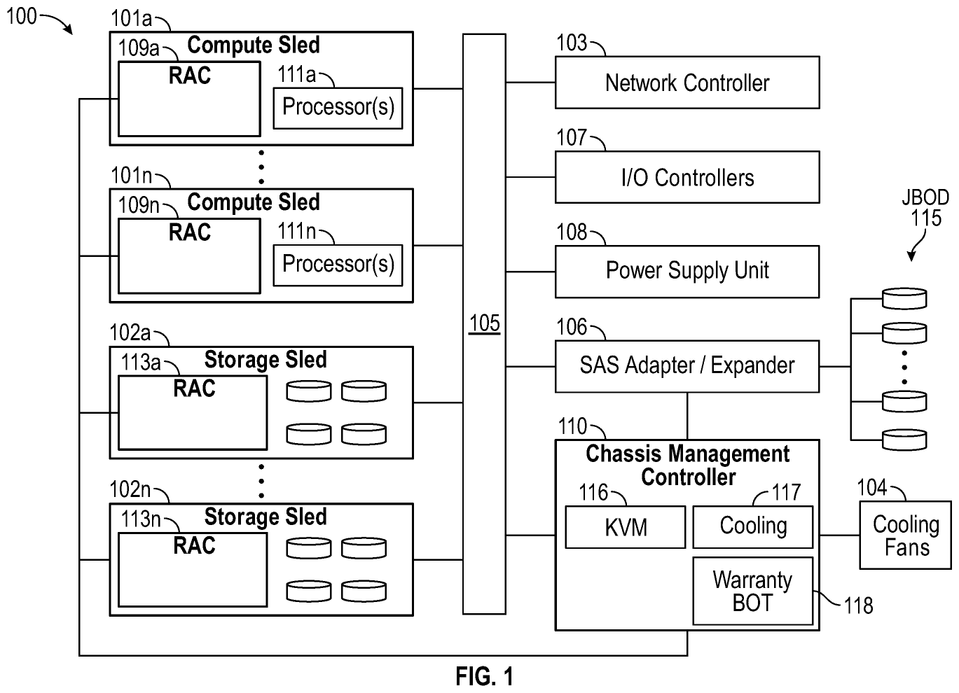

FIG. 1 is a block diagram illustrating certain components of a chassis 100 comprising one or more compute sleds 101a-n and one or more storage sleds 102a-n that may be configured to implement the systems and methods described herein. As described in additional detail below, each of the sleds 101a-n, 102a-n may be separately licensed hardware components and each of the sleds may also operate using a variety of licensed hardware and software features. Chassis 100 may include one or more bays that each receive an individual sled (that may be additionally or alternatively referred to as a tray, blade, and/or node), such as compute sleds 101a-n and storage sleds 102a-n. Chassis 100 may support a variety of different numbers (e.g., 4, 8, 16, 32), sizes (e.g., single-width, double-width), and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

By configuring a chassis 100 with different sleds, the chassis may be adapted to support specific types of operations, thus providing a computing solution that is directed toward a specific type of computational task. For instance, a chassis 100 that is configured to support artificial intelligence computing solutions may include additional compute sleds, compute sleds that include additional processors, and/or compute sleds that include specialized artificial intelligence processors or other specialized artificial intelligence components, such as specialized FPGAs. In another example, a chassis 100 configured to support specific data mining operations may include network controllers 103 that support high-speed couplings with other similarly configured chassis, thus supporting high-throughput, parallel-processing computing solutions.

In another example, a chassis 100 configured to support certain database operations may be configured with specific types of storage sleds 102a-n that provide increased storage space or that utilize adaptations that support optimized performance for specific types of databases. In other scenarios, a chassis 100 may be configured to support specific enterprise applications, such as by utilizing compute sleds 101a-n and storage sleds 102a-n that include additional memory resources that support simultaneous use of enterprise applications by multiple remote users. In another example, a chassis 100 may include compute sleds 101a-n and storage sleds 102a-n that support secure and isolated execution spaces for specific types of virtualized environments. In some instances, specific combinations of sleds may comprise a computing solution, such as an artificial intelligence system, that may be licensed and supported as a computing solution.

Multiple chassis 100 may be housed within a rack. Data centers may utilize large numbers of racks, with various different types of chassis installed in the various rack configurations. The modular architecture provided by the sleds, chassis, and rack allow for certain resources, such as cooling, power, and network bandwidth, to be shared by the compute sleds 101a-n and the storage sleds 102a-n, thus providing efficiency improvements, and supporting greater computational loads.

Chassis 100 may be installed within a rack structure that provides all or part of the cooling utilized by chassis 100. For airflow cooling, a rack may include one or more banks of cooling fans that may be operated to ventilate heated air away from a chassis 100 that is housed within a rack. Chassis 100 may alternatively or additionally include one or more cooling fans 104 that may be similarly operated to ventilate heated air from within the sleds 101a-n, 102a-n installed within the chassis. A rack and a chassis 100 installed within the rack may utilize various configurations and combinations of cooling fans 104 to cool the sleds 101a-n, 102a-n and other components housed within chassis 100.

Sleds 101a-n, 102a-n may be individually coupled to chassis 100 via connectors. The connectors may correspond to bays provided in the chassis 100 and may physically and electrically couple an individual sled 101a-n, 102a-n to a backplane 105. Chassis backplane 105 may be a printed circuit board that includes electrical traces and connectors that are configured to route signals between the various components of chassis 100. In various embodiments, backplane 105 may include various additional components, such as cables, wires, midplanes, backplanes, connectors, expansion slots, and multiplexers. In certain embodiments, backplane 105 may be a motherboard that includes various electronic components installed thereon. In some embodiments, components installed on a motherboard-type backplane 105 may include components that implement all or part of the functions described with regard to components such as network controller 103, SAS (Serial Attached SCSI) adapter/expander 106, I/O controllers 107, and power supply unit 108.

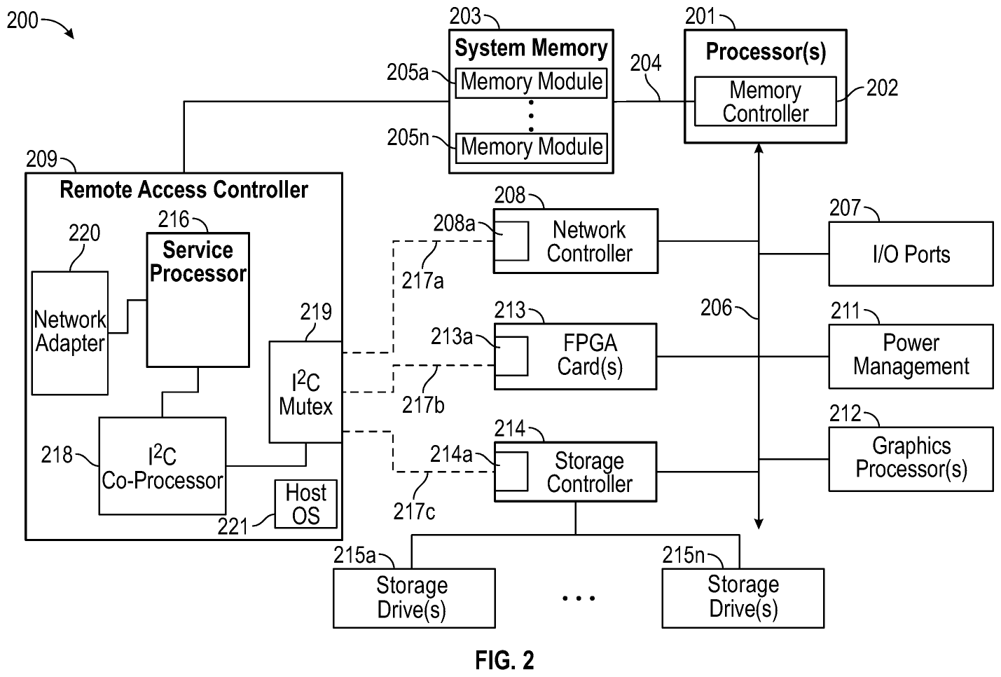

In certain embodiments, a compute sled 101a-n may be an IHS, such as described with regard to IHS 200 of FIG. 2. A compute sled 101a-n may provide computational processing resources that may be used to support a variety of e-commerce, multimedia, business, and scientific computing applications. In some cases, these applications may be provided as services via a cloud implementation. Compute sleds 101a-n are typically configured with hardware and software that provide leading-edge computational capabilities. Accordingly, services provided using such computing capabilities are typically provided as high-availability systems that operate with minimum downtime. Compute sleds 101a-n may be configured for general-purpose computing or may be optimized for specific computing tasks in support of specific computing solutions. A compute sled 101a-n may be a licensed component of a data center and may also operate using various licensed hardware and software systems.

As illustrated, each compute sled 101a-n includes a remote access controller (RAC) 109a-n. As described in additional detail with regard to FIG. 2, a remote access controller 109a-n provides capabilities for remote monitoring and management of each compute sled 101a-n. In support of these monitoring and management functions, remote access controllers 109a-n may utilize both in-band and sideband (i.e., out-of-band) communications with various internal components of a compute sled 101a-n and with other components of chassis 100. Remote access controller 109a-n may collect sensor data, such as temperature sensor readings, from components of the chassis 100 in support of airflow cooling of the chassis 100 and the sleds 101a-n, 102a-n. Also as described in additional detail with regard to FIG. 2, remote access controllers 109a-n may support communications with chassis management controller 110 where these communications may report on the status of hardware and software systems on a particular sled 101a-n, 102a-n, such as information regarding warranty coverage for a particular hardware and/or software system.

A compute sled 101a-n may include one or more processors 111a-n that support specialized computing operations, such as high-speed computing, artificial intelligence processing, database operations, parallel processing, graphics operations, streaming multimedia, and/or isolated execution spaces for virtualized environments. Using such specialized processor capabilities of a compute sled 101a-n, a chassis 100 may be adapted for a particular computing solution.

In some embodiments, each compute sled 101a-n may include a storage controller that may be utilized to access storage drives that are accessible via chassis 100. Some of the individual storage controllers may provide support for RAID (Redundant Array of Independent Disks) configurations of logical and physical storage drives, such as storage drives provided by storage sleds 102a-n. In some embodiments, some or all of the individual storage controllers utilized by compute sleds 101a-n may be HBAs (Host Bus Adapters) that provide more limited capabilities in accessing physical storage drives provided via storage sleds 102a-n and/or via SAS expander 106.

As illustrated, chassis 100 also includes one or more storage sleds 102a-n that are coupled to the backplane 105 and installed within one or more bays of chassis 100 in a similar manner to compute sleds 101a-n. Each of the individual storage sleds 102a-n may include various different numbers and types of storage devices. For instance, storage sleds 102a-n may include SAS (Serial Attached SCSI) magnetic disk drives, SATA (Serial Advanced Technology Attachment) magnetic disk drives, solid-state drives (SSDs), and other types of storage drives in various combinations. The storage sleds 102a-n may be utilized in various storage configurations by the compute sleds 101a-n that are coupled to chassis 100. As illustrated, each storage sled 102a-n may include a remote access controller (RAC) 113a-n. Remote access controllers 113a-n may provide capabilities for remote monitoring and management of storage sleds 102a-n in a similar manner to the remote access controllers 109a-n in compute sleds 101a-n.

In addition to the data storage capabilities provided by storage sleds 102a-n, chassis 100 may provide access to other storage resources 115 that may be installed as components of chassis 100 and/or may be installed elsewhere within a rack housing the chassis 100, such as within a storage blade. In certain scenarios, storage resources 115 may be accessed via SAS expander 106 that is coupled to backplane 105 of chassis 100. For example, SAS expander 106 may support connections to a number of JBOD (Just a Bunch Of Disks) storage drives 115 that may be configured and managed individually and without implementing data redundancy across the various drives 115. The additional storage resources 115 may also be at various other locations within the data center in which chassis 100 is installed. Such additional storage resources 115 may also be remotely located from chassis 100.

As illustrated, the chassis 100 of FIG. 1 includes a network controller 103 that provides network access to the sleds 101a-n, 102a-n installed within the chassis. Network controller 103 may include various switches, adapters, controllers, and couplings used to connect chassis 100 to a network, either directly or via additional networking components and connections provided via a rack in which chassis 100 is installed. In some embodiments, network controllers 103 may be replaceable components that include capabilities that support certain computing solutions, such as network controllers 103 that interface directly with network controllers from other chassis in support of clustered processing capabilities that utilize resources from multiple chassis.

Chassis 100 may also include a power supply unit 108 that provides the components of the chassis with various levels of DC power from an AC power source or from power delivered via a power system provided by the rack within which chassis 100 is installed. In certain embodiments, power supply unit 108 may be implemented within a sled that may provide chassis 100 with redundant, hot-swappable power supply units. In such embodiments, power supply unit 108 is a replaceable component that may be used in support of certain computing solutions.

Chassis 100 may also include various I/O controllers 107 that may support various I/O ports, such as USB ports that may be used to support keyboard and mouse inputs and/or video display capabilities. I/O controllers 107 may be utilized by a chassis management controller 110 to support various KVM (Keyboard, Video and Mouse) 116 capabilities that provide administrators with the ability to interface with the chassis 100.

In addition to providing support for KVM 116 capabilities for administering chassis 100, chassis management controller 110 may support various additional functions for sharing the infrastructure resources of chassis 100. In some scenarios, chassis management controller 110 may implement tools for managing the network bandwidth 103, power 108, and airflow cooling 104 that are available via the chassis 100. As described, the airflow cooling 104 utilized by chassis 100 may include an airflow cooling system that is provided by a rack in which the chassis 100 may be installed and managed by a cooling module 117 of the chassis management controller 110.

As described, components of chassis 100 such as compute sleds 101a-n and storage sleds 102a-n may include remote access controllers 109a-n, 113a-n that may collect information regarding the warranties for hardware and software systems on each sled. Chassis management controller 110 may similarly collect and report information regarding the warranties for hardware and software systems on each sled.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail with respect to FIG. 2.

IHSs 107a-d may be used to support a variety of e-commerce, multimedia, business, and scientific computing applications. In some cases, these applications may be provided as services via a cloud implementation. IHSs 107a-d are typically configured with hardware and software that provide leading-edge computational capabilities. IHSs 107a-d may also support various numbers and types of storage devices. Accordingly, services provided using such computing capabilities are typically provided as high-availability systems that operate with minimum downtime. The warranties provided by vendors of IHSs 107a-d and the related hardware and software allow the data centers 101a-d to provide contracted Service Level Agreement (SLA) to customers. Upon failure of an IHS 107a-d, data centers 101a-d and operations center 102 typically relies on a vendor to provide warranty support in order to maintain contracted SLAs.

FIG. 2 illustrates an example IHS 200 configured to implement the systems and methods described herein. It should be appreciated that although the embodiments described herein may describe an IHS that is a compute sled or similar computing component that may be deployed within the bays of a chassis, other embodiments may be utilized with other types of IHSs. In the illustrative embodiment of FIG. 2, IHS 200 may be a computing component, such as compute sled 101a-n, that is configured to share infrastructure resources provided by a chassis 100 in support of specific computing solutions.

IHS 200 may be a compute sled that is installed within a large system of similarly configured IHSs that may be housed within the same chassis, rack and/or data center. IHS 200 may utilize one or more processors 201. In some embodiments, processors 201 may include a main processor and a co-processor, each of which may include a plurality of processing cores that, in certain scenarios, may each be used to run an instance of a server process. In certain embodiments, one, some or all processor 201 may be graphics processing units (GPUs). In some embodiments, one, some or all processor 201 may be specialized processors, such as artificial intelligence processors or processor adapted to support high-throughput parallel processing computations. As described, such specialized adaptations of IHS 200 may be used to implement specific computing solutions support by the chassis in which IHS 200 is installed.

As illustrated, processor 201 includes an integrated memory controller 202 that may be implemented directly within the circuitry of the processor 201, or memory controller 202 may be a separate integrated circuit that is located on the same die as the processor 201. Memory controller 202 may be configured to manage the transfer of data to and from a system memory 203 of the IHS 201 via a high-speed memory interface 204.

System memory 203 is coupled to processor 201 via a memory bus 204 that provides the processor 201 with high-speed memory used in the execution of computer program instructions by the processor 201. Accordingly, system memory 203 may include memory components, such as such as static RAM (SRAM), dynamic RAM (DRAM), or NAND Flash memory, suitable for supporting high-speed memory operations by the processor 201. In certain embodiments, system memory 203 may combine both persistent, non-volatile memory, and volatile memory.

In certain embodiments, system memory 203 may be comprised of multiple removable memory modules. System memory 203 in the illustrated embodiment includes removable memory modules 205a-n. Each of the removable memory modules 205a-n may correspond to a printed circuit board memory socket that receives a removable memory module 205a-n, such as a DIMM (Dual In-line Memory Module), that can be coupled to the socket and then decoupled from the socket as needed, such as to upgrade memory capabilities or to replace faulty components. Other embodiments of IHS system memory 203 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 201. All or portions of the chipset may be implemented directly within the integrated circuitry of an individual processor 201. The chipset may provide the processor 201 with access to a variety of resources accessible via one or more buses 206. Various embodiments may utilize any number of buses to provide the illustrated pathways served by bus 206. In certain embodiments, bus 206 may include a PCIe (PCI Express) switch fabric that is accessed via a PCIe root complex. IHS 200 may also include one or more I/O ports 207, such as PCIe ports, that may be used to couple the IHS 200 directly to other IHSs, storage resources or other peripheral components. In certain embodiments, the I/O ports 207 may provide couplings to the backplane of the chassis in which the IHS 200 is installed.

As illustrated, a variety of resources may be coupled to the processor 201 of the IHS 200 via bus 206. For instance, processor 201 may be coupled to a network controller 208, such as provided by a Network Interface Controller (NIC) that is coupled to the IHS 200 and allows the IHS 200 to communicate via an external network, such as the Internet or a LAN. As illustrated, network controller 208 may report information to a remote access controller 209 via an out-of-band signaling pathway that is independent of the operating system of the IHS 200.

Processor 201 may also be coupled to a power management unit 211 that may interface with power system unit 108 of chassis 100 in which an IHS 200, such as a compute sled 101a-n, may be installed. In certain embodiments, a graphics processor 212 may be comprised within one or more video or graphics cards, or an embedded controller, installed as components of IHS 200. In certain embodiments, graphics processor 212 may be an integrated of the remote access controller 209 and may be utilized to support the display of diagnostic and administrative interfaces related to IHS 200 via display devices that are coupled, either directly or remotely, to remote access controller 209.

As illustrated, IHS 200 may include one or more FPGA (Field-Programmable Gate Array) card(s) 213. Each of the FPGA cards 213 supported by IHS 200 may include various processing and memory resources, in addition to an FPGA integrated circuit that may be reconfigured after deployment of IHS 200 through programming functions supported by FPGA card 213. Each individual FGPA card 213 may be optimized to perform specific processing tasks, such as specific signal processing, security, data mining, and artificial intelligence functions, and/or to support specific hardware coupled to IHS 200. In certain embodiments, such specialized functions supported by an FPGA card 213 may be utilized by IHS 200 in support of certain computing solutions. As illustrated, FPGA 213 may report information to the remote access controller 209 via an out-of-band signaling pathway that is independent of the operating system of the IHS 200.

IHS 200 may also support one or more storage controllers 214 that may be utilized to provide access to virtual storage configurations. For instance, storage controller 214 may provide support for RAID (Redundant Array of Independent Disks) configurations of storage devices 215a-n, such as storage drives provided by storage sleds 102a-n and/or JBOD 115 of FIG. 1. In some embodiments, storage controller 214 may be an HBA (Host Bus Adapter). Storage controller 214 may report information to the remote access controller 209 via an out-of-band signaling pathway that is independent of the operating system of the IHS 200.

In certain embodiments, IHS 200 may operate using a BIOS (Basic Input/Output System) that may be stored in a non-volatile memory accessible by the processor(s) 201. The BIOS may provide an abstraction layer by which the operating system of the IHS 200 interfaces with the hardware components of the IHS. Upon powering or restarting IHS 200, processor 201 may utilize BIOS instructions to initialize and test hardware components coupled to the IHS, including both components permanently installed as components of the motherboard of IHS 200, and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 209.

In certain embodiments, remote access controller 209 may operate from a different power plane from the processors 201 and other components of IHS 200, thus allowing the remote access controller 209 to operate, and management tasks to proceed, while the processing cores of IHS 200 are powered off. As described, various functions provided by the BIOS, including launching the operating system of the IHS 200, may be implemented by the remote access controller 209. In some embodiments, the remote access controller 209 may perform various functions to verify the integrity of the IHS 200 and its hardware components prior to initialization of the IHS 200 (i.e., in a bare-metal state).

Remote access controller 209 may include a service processor 216, or specialized microcontroller, that operates management software that supports remote monitoring and administration of IHS 200. Remote access controller 209 may be installed on the motherboard of IHS 200 or may be coupled to IHS 200 via an expansion slot provided by the motherboard. In support of remote monitoring functions, network adapter 208c may support connections with remote access controller 209 using wired and/or wireless network connections via a variety of network technologies.

In some embodiments, remote access controller 209 may support monitoring and administration of various devices 208, 213, 214 of an IHS via a sideband interface. In such embodiments, the messages in support of the monitoring and management function may be implemented using MCTP (Management Component Transport Protocol) that may be transmitted using I2C sideband bus connections 217a-c established with each of the respective managed devices 208, 213, 214. As illustrated, the managed hardware components of the IHS 200, such as FPGA cards 213, network controller 208 and storage controller 214, are coupled to the IHS processor 201 via an in-line bus 206, such as a PCIe root complex, that is separate from the I2C sideband bus connection 217a-c.

In certain embodiments, the service processor 216 of remote access controller 209 may rely on an I2C co-processor 218 to implement sideband I2C communications between the remote access controller 209 and managed components 208, 213, 214 of the IHS. The I2C co-processor 218 may be a specialized co-processor or micro-controller that is configured to interface via a sideband I2C bus interface with the managed hardware components 208, 213, 214 of IHS. In some embodiments, the I2C co-processor 218 may be an integrated component of the service processor 216, such as a peripheral system-on-chip feature that may be provided by the service processor 216. Each I2C bus 217a-c is illustrated as single line in FIG. 2. However, each I2C bus 217a-c may be comprised of a clock line and data line that couple the remote access controller 209 to I2C endpoints 208a, 213a, 214a.

As illustrated, the I2C co-processor 218 may interface with the individual managed devices 208 , 213, and 214 via individual sideband I2C buses 217a-c selected through the operation of an I2C multiplexer 219. Via switching operations by the I2C multiplexer 219, a sideband bus connection 217a-c may be established by a direct coupling between the I2C co-processor 218 and an individual managed device 208, 213, or 214.

In providing sideband management capabilities, the I2C co-processor 218 may each interoperate with corresponding endpoint I2C controllers 208a, 213a, 214a that implement the I2C communications of the respective managed devices 208, 213, 214. The endpoint I2C controllers 208a, 213a, 214a may be implemented as a dedicated microcontroller for communicating sideband I2C messages with the remote access controller 209, or endpoint I2C controllers 208a, 213a, 214a may be integrated SoC functions of a processor of the respective managed device endpoints 208, 213, 214.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor 201 as a systems-on-a-chip.

In some embodiments, the remote access controller 209 may include or may be part of a baseboard management controller (BMC). As a non-limiting example of a remote access controller 209, the integrated Dell Remote Access Controller (iDRAC) from Dell® is embedded within Dell PowerEdge™ servers and provides functionality that helps information technology (IT) administrators deploy, update, monitor, and maintain servers remotely. In other embodiments, chassis management controller 110 may include or may be an integral part of a baseboard management controller. Remote access controller 209 may be used to monitor, and in some cases manage computer hardware components of IHS 200. Remote access controller 209 may be programmed using a firmware stack that configures remote access controller 209 for performing out-of-band (e.g., external to a computer's operating system or BIOS) hardware management tasks. Remote access controller 209 may run a host operating system (OS) 221 on which various agents execute. The agents may include, for example, a service module 250 that is suitable to interface with remote access controller 209 including, but not limited to, an iDRAC service module (iSM).

IHSs vendors offer diverse warranty types with various SLAs and support. Typically, customers choose a warranty for the IHSs they buy based on their needs and based on their knowledge and experience. Warranty requirements differ based on the market segment (e.g., automotive, web technologies, finance, banking, etc.) as well as the workload needs (customer relationship management (CRM), business management, mail/calendaring server, real-time data processing, LAMP stack, etc.). Each workload has a different priority across different industries based on how they influence the business.

Currently, customers do not have collective market intelligence to assist in making warranty decisions. Initially customers tend to go with the vendor's recommendations. Later, based on experience, customers may end or modify some warranty options. Finally, when the customer has to deal with hard issues such as server failure events, they start configuring the correct warranty options. Some of the reasons that make warranty selection difficult for customers include:
New customers who are not aware of the vendor's warranty models;
Vendors who enter a new market segment with customers that have a unique or different workload compared to an existing customer base;
New evolutions in technology as well as market segment needs that require new warranty expectations;
New SLA definitions based on recent experiences in the market segment (e.g., GDP, privacy laws, and additional disaster recovery needs); and
Warranty needs that vary with workloads in a market segment due to specific behaviors in that segment. For example, the finance and banking industries require faster and definitive SLAs, whereas the automotive and web technology industries usually create their own frameworks for handling hardware/software downtime and, therefore, have different warranty needs.

In an example embodiment, workloads for a virtual storage area network (VSAN) or software-defined storage (SDS) in a banking or finance segment may not use the same warranty as a web technologies warranty. While an NBD (Next Business Day) or SBD (Second Business Day) warranty may be acceptable for the web technologies industry, critical warranties such as 4-hour or 8-hour SLAs are required in the banking and finance industry due to the impact of downtime on the business. Similarly, web technology companies may require less part-replacement warranties, while companies in the automotive industry rely on software technologies, which requires less part replacement.

In one embodiment, a multi-level, collaborative-filtering based warranty recommendation is used to identify the desired level of warranty for new or existing users based upon the community or market segment to which that user belongs. This solution may be deployed using cloud-based proactive monitoring and predictive analytics, such as CloudIQ from Dell Inc., where the computation for a warranty recommendation may be executed.

The solution is categorized into at least two categories: presale recommendations and customer recommendations. A presale collaborative filtering-recommendation is made at the time of purchase using, for example, a vendor sales tool. The vendor's sales team recommends the best warranty based on feedback and data from similar companies in the same industry segment. A customer collaborative filtering recommendation can be made in a systems management tools, such as the Dell EMC OpenManage Enterprise (OME) or Dell EMC SupportAssist Enterprise (SAE). The recommendations are made available through these tools based on the changes in the usage pattern of the other users in the same market segment. Customers can use the customer-collaborative recommendation to upgrade warranties based on other users' experience.

Users receive customized warranty recommendations that are market segment specific based on multiple factors such as SLA, level of downtime, usage in peer groups, or expert advice. The collaborative filtering is extended in multiple stages. In one embodiment, a proposed multi-level collaborative filtering-based warranty recommendation consists of the following stages:

Stage 1: Peer group discovery and preliminary warranty recommendation.

In this state, significant properties, such as workload type and market segment, are combined with other properties, such as virtual machine (VM) sizing and cost, from various datacenters and deployments. These properties are collected and processed to find related user groups.

Stage 2: Detect changes in warranty sets within peer group.

Changes in peer group behavior are monitored. Changes from a previous warranty recommendation to a current warranty recommendation based on changes in the behavior of a peer group over the course of time are broadcast and propagated to users within that peer group. After a suggested warranty level is recommended to a new user or an upgrading existing user, it may happen that other users in the same peer group move from one warranty set to another warranty set. These changes in the warranty sets are identified, and then the changes are suggested to users to be consistent. Warranties are ranked to be recommend in correspondence with similar users based on the market segment and workloads. In this stage, a new warranty for a peer group is determined using the technique explained described in Stage 1, and then the new recommendation is provided to the peer group to ensure consistency.

Stage 3: Compute and propagate warranty ranks.

In this stage, warranty ranks are computed and then changes are broadcast and propagated within peer groups. The changes in warranty ranking may be used by customers to switch to more popular warranties. Peer group classification is based on workloads and market segment. There may be multiple warranties W1, W2, . . . , Wn that are recommended based on similar users. These warranties may be ranked based on usage in the peer group. Ranking of warranties may be accomplished by creating a hash table with the key as a unique warranty identifier and a value equal to the number of users using that particular warranty. The hash table is sorted in decreasing order of the values, and the ranking list of warranties is generated. The warranty rankings may also be published as part of a user or peer group change in Stage 2.

Stage 4: Expert user recommendation.

Particular users can be tagged as expert users based on factors such as star ratings and sentimental analysis of review comments. In the peer groups for those particular users, their recommendations can be considered as expert user recommendations. Warranties may be ranked on the basis of expert user advice. Recognized experts in an industry or segment may provide comments or other feedback, and any user may provide a star rating for the warranties. The expert review comments can be considered in conjunction with the star ratings in order to generate an expert user recommendation.

Expert users may be ranked themselves, such as type A, B, or C users. The expert users may submit their recommendations to a vendor cloud. The customers may provide ratings for workload type and the warranties used in their system These recommendations will be tagged with the primary variables (e.g., workload type and market segment) for which the user is considered as an expert. Type A Expert Users are special types of users who submit proposals regarding warranty sets based on their knowledge. Type B Expert Users are based on ratings from customers and are correlated to a specific market segment. Type C Expert Users are customers who give review comments along with a star rating. Review comments express the true notion of sentiments behind a particular warranty. Vendors may prefer to use review comments for ranking of a particular warranty only if there are more than half of the customers giving review comments; otherwise, star ratings are preferred. When considering review comments, the vendor performs a sentiment analysis of the comments after preprocessing of the data. A polarity greater than 0.5 would be classified as positive, polarity in range [−0.5, 0.5] would be neutral, and polarity lesser than −0.5 would be classified as negative. Warranties may be ranked with a decreasing order of polarity. When considering star rating, an average of the ratings for each of the warranties is calculated, and a ranked list of the warranties is prepared on the basis of the average star rating.

Stage 5: Cost impact in recommendation.

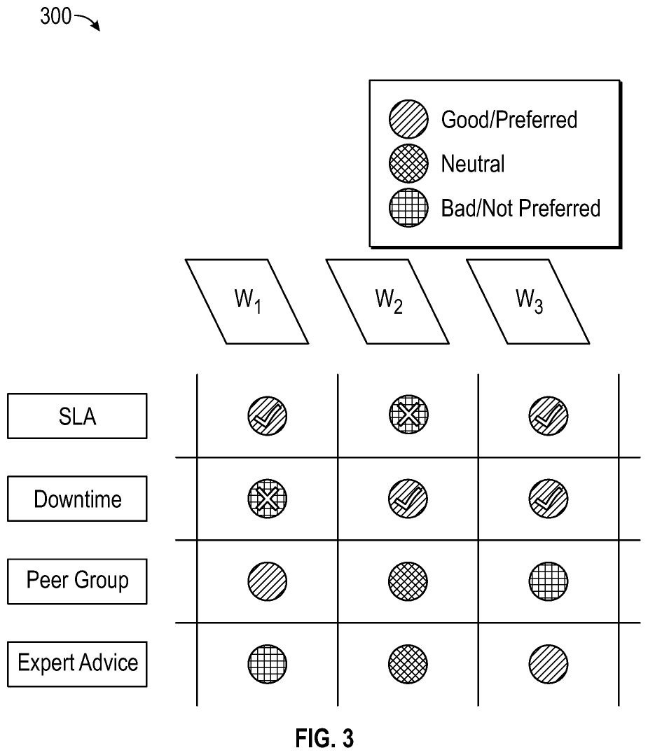

Many users will be concerned about the cost of the warranties suggested in the above stages. In this step, the impact on different IT attributes (e.g., SLA, downtime, etc.) or peer group/expert behavior is computed based on the warranty cost. FIG. 3 is a chart 300 illustrating an impact assessment for different warranties W1-W3. Impact assessment shows relative ratings against attributes including downtime, SLA, peer group, and expert advice for each warranty. Cost recommendations are concerned with the properties that might get impacted when the user makes a transition from one warranty to another. As depicted, if a customer moves from warranty W1 to warranty W2, then the SLA will get impacted whereas there will be less downtime for W2. Higher ranked warranties in the peer group are depicted as the most preferred warranties whereas lower ranked warranties are depicted as not-preferred warranties with suitable impact assessment for other attributes like SLA and downtime.

The warranty recommendations may be computed within a cloud-based proactive monitoring and predictive analytics tool and then propagated to users via a system management tool. New warranty suggestions may be propagated to all users in a peer group, for example, using alerts in a server management tool.

The use of separate sets of attributes (primary variables) and secondary variables for computation of peer groups is not used in existing warranty systems. The primary variables are the workload type and the market segment, which are used to construct peer groups. Existing warranty systems also lack the ability for continuous computation of changes in warranty sets based on customer usage patterns. Moreover, existing warranty systems do not provide automated computation of warranty ranks based on usage pattern in the peer groups. Finally, existing systems do not incorporate expert user recommendations into the warranty recommendation process.

One or more of the functions involved in warranty rankings, such as data sourcing, identifying peers, detecting changes in warranties, computing warranty ranks, collecting expert user advice, and evaluating cost concerns, may be automated and performed in an artificial intelligence (AI) or machine learning (ML) engine or processor that executes software instructions that operate to combine large amounts of data with fast, iterative processing and intelligent algorithms, which thereby allow the software to automatically learn from patterns and features in the data. The AI/ML device may be hosed on an IHS and may use machine learning, which automates analytical model building using methods from neural networks and statistics to find insights into data without explicitly programming regarding what to look for and what to conclude. The AI/ML device may use a neural network that is made up of interconnected units that process information by responding to external inputs and relaying information between each unit. The process may require multiple iterations processing the data to find connections and derive meaning from unstructured data. The AI/ML device may use advanced algorithms to analyze large amounts of data faster and at multiple levels. This allows intelligent processing for identifying and predicting rare events, understanding complex systems, and identifying unique scenarios. The AI/ML device may use application programming interfaces (APIs) to add functionality to existing systems and software. The AI/ML device can reason on input data and output an explanation of the data.

AI/ML algorithms for ranking warranties are trained using an appropriate set of parameters. For example, the AI/ML device may be trained using parameter related to workload type, market segment, VM sizing, number of VMs, cluster size, cost, downtime, warranty SLAs and other terms and conditions. The algorithm generates recommendations for recommending warranties to customers based on market segment. The warranty data is categorized by assigning weights and bias to each parameter and identifying opportunities to group warranties and customers by industry groups.

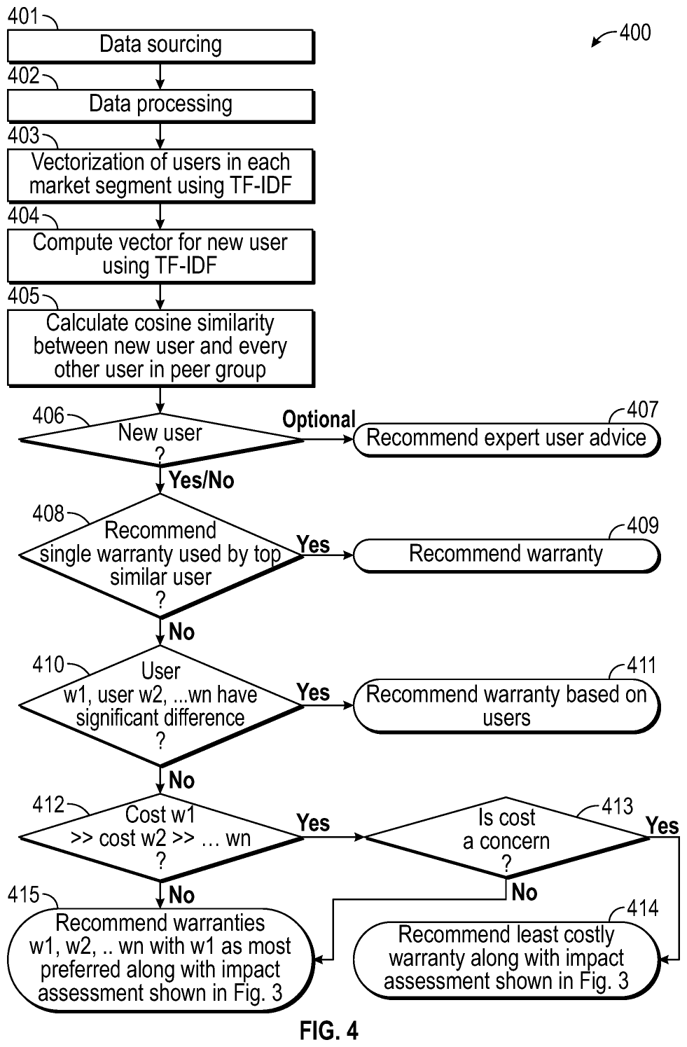

FIG. 4 is a flowchart illustrating a process 400 for data preprocessing and recommendation according to an example embodiment. In step 401, various data sources are identified. As part of data preparation, various distinct properties for a user in a particular market segment are considered, such as primary variables (e.g., workload type, market segment) and secondary variables (e.g., number of VMs deployed for the workload, VM sizing, cluster size, cost, and level of downtime). Peer groups are created based upon this data. In step 402, the data is preprocessed. Some of the primary or secondary variables may contain textual data that will require text preprocessing. Text preprocessing includes conversion of text data into lowercase and splitting the text into words. Tokenization preprocessing may also be used to remove stop words.

In step 403, one or more vectors are created. Vectorization is a form of word embedding. Term Frequency-Inverse Document Frequency (TF-IDF) is utilized to create a vector representation for each user in a particular community or market segment. In step 404, a vector is computed for new users by TF-IDF with high importance being assigned to the primary variables noted above. Once market segment and new users' vectors are created, then similarities between users can be identified. To group users, an unsupervised clustering methodology based on a distance measurement algorithm is used.

In step 405, a cosine similarity is used as a distance algorithm for computing clusters. The cosine similarity is calculated between each new user and the previously identified peer groups (i.e., community or market segment). Based on the cosine similarity, new peer-group clusters are discovered and/or new users are matched to a peer-group cluster based upon the least distance between a user and a cluster.

In step 406, a determination is made whether the user is a new user. If the user is new, then they may optionally be offered expert advice regarding warranty options in step 407; otherwise, new users and existing users seeking a warranty review/update move to step 408. In step 408, a determination is made whether the recommendation is for a single warranty by a top similar user. If so, the in step 409 a warranty recommendation is created by identifying the top similar user in the same peer group and then recommending the warranty used by that top similar user. If more than one warranty is recommended, then in step 410 a determination is made whether there is a significant difference between the prior users who have used the recommended group of warranties. If so, then in step 411, a warranty is recommended based on which prior user is closest to the current user.

If there is no significant difference among the users in step 410, then in step 412 a comparison is made among the warranties' costs. If there are significant cost differences, then in step 413 a decision is made whether the customer has indicated that cost is a concern. If cost is a concern, then in step 414 the least costly warranty is recommended to the customer along with an impact assessment for that warranty with respect to SLA, downtime, peer group, and expert advice similar to the example shown in FIG. 3. If cost is not a concern in step 413, or if there are not significant cost differences between the group of warranties, then in step 415 the group of warranties are recommended to the customer with the highest ranked warranty identified as most preferred. The customer is also provided an impact assessment for group of warranties with respect to SLA, downtime, peer group, and expert advice for each warranty similar to the example shown in FIG. 3. The customer may then select from the among the offered warranties.

In an example embodiment, a method for filtering warranty offers based on user peer groups comprises collecting data associated with a plurality of warranty users, wherein the data corresponds to a set of primary variables and a set of secondary variables; creating a vector representation of each user using TF-IDF; identifying two or more clusters of warranty users, wherein each cluster is created using a cosine similarity comparison of the user vector representations; identifying a top similar user for each cluster; determining a warranty type for each top similar user; and notifying other users within each cluster of the warranty type associated with the top similar user for that cluster. Each of the two or more clusters of warranty users are associated with a different market segment.

The method for filtering warranty offers may further comprise creating a vector representation for a new user using TF-IDF, calculating a cosine similarity between the new user vector and a closest top similar user, and notifying the new user of the warranty type associated with the closest top similar user.

The set of primary variables may comprise one or more of workload type data and market segment data. The set of secondary variables may comprise one or more of a virtual machine size, a number of virtual machines, a cluster size, a cost, and a level of downtime.

Each cluster may correspond to a peer group, and the method for filtering warranty offers may further comprise determining when a user within a peer group has changed to a warranty; identifying a new top similar user for the peer group; determining a warranty type for the new top similar user; and notifying other users within the peer group of the warranty type associated with the new top similar user.

The method for filtering warranty offers may further comprise identifying each warranty used by members of a cluster; rank the warranties for the cluster based upon a number of users for each warranty; and publishing a top warranty for the cluster to other members of the cluster.

The method for filtering warranty offers may further comprise collecting a group of user rankings for warranties used within a cluster; collecting review comments regarding the warranties used within the cluster; and generating an expert user recommendation for one or more of the warranties used within the cluster. The expert user recommendation may correspond to a highest average rating for the warranty.

The method for filtering warranty offers may further comprise, for a plurality of warranties, creating an indication for each warranty whether the warranty is preferred or not preferred for one or more of the primary variables and secondary variables.

In another example embodiment, a computer program product comprises a computer readable storage medium having program instructions embodied therewith. The program instructions are executable by a processor to cause the processor to perform a method comprising identifying, using a machine learning algorithm, a plurality of peer groups among a number of warranty users, wherein the peer groups correspond to market segments or industries; identifying, using the machine learning algorithm, a top similar user within a selected peer group for a new user, wherein the top similar user is selected based upon a cosine similarity of vector models representing the top similar user and the new user; and notifying the new user of a preferred warranty, wherein the preferred warranty corresponds to a current warranty associated with the top similar user.

The program instructions may further cause the processor to identify when a user assigned to a peer group has changed to a new warranty; create a ranking of current warranties within the peer group that includes the new warranty; and notify users in the peer group of the ranking of current warranties. Notifying users of the ranking of current warranties may comprise, for example, identifying a top warranty among the current warranties. The top warranty may correspond to a warranty that is used most often by users with the peer group.

The ranking of current warranties may be based upon data corresponding to a set of primary variables and a set of secondary variables. The set of primary variables may comprise one or more of workload type data and market segment data, and the set of secondary variables may comprise one or more of a virtual machine size, a number of virtual machines, a cluster size, a cost, and a level of downtime. The program instructions may further cause the processor to determine whether each warranty of the current warranties is preferred or not preferred or neutral for one or more of the set of primary variables and the set of secondary variables.

The program instructions may further cause the processor to collect user rankings of current warranties associated with users in a peer group; collect review comments regarding current warranties associated with users in a peer group; and create a ranked list of the current warranties based upon average values of the user ranking and review comments.

The program instructions may further cause the processor to create a ranking of current warranties within the peer group, wherein the ranking is sorted based upon warranty cost.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A method for filtering warranty offers based on user peer groups, comprising:
collecting data associated with a plurality of warranty users, wherein the data corresponds to a set of primary variables and a set of secondary variables;
creating a vector representation of each user using Term Frequency-Inverse Document Frequency (TF-IDF);
identifying two or more clusters of warranty users, wherein each cluster is created using a cosine similarity comparison of the user vector representations;
identifying a top similar user for each cluster;
determining a warranty type for each top similar user; and
notifying other users within each cluster of the warranty type associated with the top similar user for that cluster.

2. The method of claim 1, further comprising:
creating a vector representation for a new user using TF-IDF;
calculating a cosine similarity between the new user vector and a closest top similar user; and
notifying the new user of the warranty type associated with the closest top similar user.

3. The method of claim 1, wherein the set of primary variables comprises one or more of workload type data and market segment data, and wherein the set of secondary variables comprises one or more of a virtual machine size, a number of virtual machines, a cluster size, a cost, and a level of downtime.

4. The method of claim 1, wherein each of the two or more clusters of warranty users are associated with a different market segment.

5. The method of claim 1, wherein each cluster corresponds to a peer group, and the method further comprising:
determining when a user within a peer group has changed to a warranty;
identifying a new top similar user for the peer group;
determining a warranty type for the new top similar user; and
notifying other users within the peer group of the warranty type associated with the new top similar user.

6. The method of claim 1, further comprising:
identifying each warranty used by members of a cluster;
rank the warranties for the cluster based upon a number of users for each warranty; and
publishing a top warranty for the cluster to other members of the cluster.

7. The method of claim 1, further comprising:
collecting a group of user rankings for warranties used within a cluster;
collecting review comments regarding the warranties used within the cluster; and
generating an expert user recommendation for one or more of the warranties used within the cluster.

8. The method of claim 7, wherein the expert user recommendation corresponds to a highest average rating for the warranty.

9. The method of claim 1, further comprising:
for a plurality of warranties, creating an indication for each warranty whether the warranty is preferred or not preferred for one or more of the primary variables and secondary variables.

10. A computer program product comprising a computer readable storage medium having program instructions embodied therewith, the program instructions executable by a processor to cause the processor to perform a method comprising:
identifying, using a machine learning algorithm, a plurality of peer groups among a number of warranty users, wherein the peer groups correspond to market segments or industries;
identifying, using the machine learning algorithm, a top similar user within a selected peer group for a new user, wherein the top similar user is selected based upon a cosine similarity of vector models representing the top similar user and the new user; and
notifying the new user of a preferred warranty, wherein the preferred warranty corresponds to a current warranty associated with the top similar user.

11. The computer program product of claim 10, wherein the program instructions further cause the processor to perform a method comprising:
identifying when a user assigned to a peer group has changed to a new warranty;
creating a ranking of current warranties within the peer group that includes the new warranty; and
notifying users in the peer group of the ranking of current warranties.

12. The computer program product of claim 11, wherein notifying users of the ranking of current warranties comprises identifying a top warranty among the current warranties.

13. The computer program product of claim 12, wherein the top warranty corresponds to a warranty that is used most often by users with the peer group.

14. The computer program product of claim 11, wherein the ranking of current warranties is based upon data corresponding to a set of primary variables and a set of secondary variables.

15. The computer program product of claim 14, wherein the set of primary variables comprises one or more of workload type data and market segment data, and wherein the set of secondary variables comprises one or more of a virtual machine size, a number of virtual machines, a cluster size, a cost, and a level of downtime.

16. The computer program product of claim 14, wherein the program instructions further cause the processor to perform a method comprising:
determining whether each warranty of the current warranties is preferred or not preferred or neutral for one or more of the set of primary variables and the set of secondary variables.

17. The computer program product of claim 10, wherein the program instructions further cause the processor to perform a method comprising:
collecting user rankings of current warranties associated with users in a peer group;
collecting review comments regarding current warranties associated with users in a peer group; and
creating a ranked list of the current warranties based upon average values of the user ranking and review comments.

18. The computer program product of claim 11, wherein the program instructions further cause the processor to perform a method comprising:
creating a ranking of current warranties within the peer group, wherein the ranking is sorted based upon warranty cost.
